(19) United States
(12) Patent Application Publication
(10) Pub. No.: US 2015/0107024 A1
(43) Pub. Date: Apr. 23, 2015

(54) Roller Support Electric Bed

(71) Applicant: JIANCHUN XU, Jiaxing City (CN)

(72) Inventor: JIANCHUN XU, Jiaxing City (CN)

(73) Assignee: JIAXING SHUFUDE ELECTRIC BED CO., LTD, Zhejiang (CN)

(21) Appl. No.: 14/301,093

(22) Filed: Jun. 10, 2014

(30) Foreign Application Priority Data
Oct. 23, 2013 (CN) 201320654810X

(51) Int. Cl. A47C 20/04; A61G 7/015

(52) U.S. Cl. CPC A47C 20/041; A61G 7/015
USPC 5/616

(57) ABSTRACT

An electric bed has a first bed board and a second bed board, which are hinged with each other, and a bed frame, a head bracket, a head driving motor, and a head pull rod. The bed frame has an upper bed frame and a lower bed frame. The second bed board and the upper bed frame are fixedly connected in a dismountable mode. The upper bed frame and the lower bed frame are connected by a guide rail connecting structure so that the upper bed frame can move relative to the lower bed frame. One end of the head bracket is hinged with the bed frame and another end of the head bracket is supported against the first bed board.

This application claims priority from and is a Paris Convention Treaty of non-provisional application of: People's Republic of China utility model patent application 201320654810.X entitled Electric Bed, filed Oct. 23, 2013, by inventor Xu, Jianchun; the disclosures of which are incorporated herein by reference.

### FIELD OF THE INVENTION

The utility model relates to an electric bed having a roller support.

### BACKGROUND

Electric beds have become more popular recently. The bed board of a common electric bed is formed by hinging multiple boards together. A motor is hinged with a bed frame, and the bed boards are pushed by extension or retraction of a motor-driven rod to raise or lower around a hinge joint so that a head board, a seat board or a leg board is lifted to meet postural change requirements during use.

Nonetheless, most motor-driven rods are connected to the bed board by a screw at present. As most bed boards are wooden with softer characteristics than metal, the pressure from the driving rod concentrates on the bed board during lifting of the bed board causing the screw for fixing the driving rod to become loose and damage the bed board. This affects the service life of the electric bed. At the same time, due to space limitations, the driving force arm of the motor is shorter which makes the motor load larger so that it is possible to damage the motor and impact the service life due to a motor overload. If a motor with large load capacity were used, production cost and weight of the electric bed could increase.

### SUMMARY OF THE INVENTION

The present invention seeks to provide an electric bed without the above defects. The electric bed at least comprises a first bed board and a second bed board, which are hinged with each other and supported on a bed frame. The bed frame has an upper bed frame and a lower bed frame. The electric bed further comprises a head bracket, a head driving motor, and head pull rod.

The second bed board and the upper bed frame are fixedly connected in a dismountable mode, and the upper bed frame and the lower bed frame are connected by a guide rail connecting structure so that the upper bed frame can move relative to the lower bed frame. One end of the head bracket is hinged with the bed frame, and another end of the head bracket is supported against the first bed board. The head driving motor is fixed on the lower bed frame. The push rod of the driving motor is hinged in a position close to another end of the head bracket and crossly arranged with the head bracket. The head driving motor can move back-and-forth between an immobile position and a mobile position. In the immobile position, the first bed board is in a horizontal position, whereas in the mobile position, the first bed board is in a raising position. When the first bed board moves toward the raising position from the horizontal position, the head pull rod makes fixed-axis rotation with the first bed board so that the upper bed frame is driven to move relative to the lower bed frame.

Furthermore, another end of the head bracket supported against the first bed board comprises a guiding element so that the first bed board arises or falls.

Furthermore, the first bed board comprises a guiding device for receiving the guiding element to ensure the guiding element moves along the direction set by the guiding device.

Furthermore, the head bracket has at least one reinforcing rib plate.

Furthermore, the head bracket comprises a rectangular tube.

Furthermore, when the head driving motor operates, it drives the head bracket hinged with its driving rod to rotate around a primary shaft and another end of the head bracket to rotate against the first bed board so that the first bed board rotates around a second shaft to form double-axis rotation.

Furthermore, the electric bed further comprises a second bed board and a third bed board, which are hinged with each other, a foot bracket, a foot driving motor. One end of the foot bracket is hinged with the bed frame. Another end of the foot bracket is supported against the third bed board. The foot driving motor is fixed on the upper bed frame. The push rod of the driving motor is hinged in a position close to another end of the head bracket and crossly arranged with the head bracket. The foot driving motor can move back-and-forth between an immobile position and a mobile position. In the immobile position, the third bed board is in a horizontal position, whereas in the mobile position, the third bed board is in a raising position.

Furthermore, the electric bed further comprises a supporting block for supporting the bed board positioned in the horizontal position.

One end of the head bracket of the electric bed is hinged with the bed frame, and another end is supported against the first bed board. One end of the head driving motor is hinged with the lower bed frame. Another end is hinged with the head bracket to indirectly push the first bed board. The head bracket is used to increase force arm and improve torque so that the first bed board rises. Therefore, the problems of a traditional electric bed are solved, such as short force arm, larger load and easy damage to the bed board.

### BRIEF DESCRIPTION OF THE DRAWINGS

FIG. 1 is a structure diagram of the electric bed in upward view, with the head driving motor in the immobile position.

FIG. 2 is a cross section of the electric bed sectioned along the center line, with the head driving motor in the mobile position.

FIG. 3 is a perspective drawing of the head bracket provided in an embodiment according to the utility model.

The following callout list of elements can be a useful guide in referencing the elements of the drawings.

A First Shaft

B Second Shaft

C Third Shaft

1 First Bed Board

2 Second Bed Board

3 Third Bed Board

8 Front Electrical Expansion Link

11 Head Bracket

12 Head Driving Motor

13 Head Pull Rod

21 Upper Bed Frame

22 Lower Bed Frame

33 Pulley Wheel

34 Guide Rail

61 Two Side Substrates

62 Cross-bar

63 Bracket

64 Two Guide Wheels

65 Rib Plate

66 Reinforcing Rib

80 Supporting Block

110 Foot Bracket

120 Foot Driving Motor

### DETAILED DESCRIPTION OF THE PREFERRED EMBODIMENT

The head bracket 11 has a roller support using the wheels 64 that roll on an underside surface of the first bed board 1. The foot bracket 110 has a roller support using the wheels 64 that roll on an underside surface of the third bed board 3. The first bed board 1 is the head board for supporting the head of a user. The second bed board 2 is the seat board for supporting a seat for the user. The third bed board 3 is in the leg board for supporting the legs of a user. The first bed board 1 is hinged to the second bed board 2 which is hinged to the third bed board 3. The third bed board can be hinged into a thigh board section and a calf board section. The first bed board 1 has a raised position and a horizontal position with an intermediate raising position.

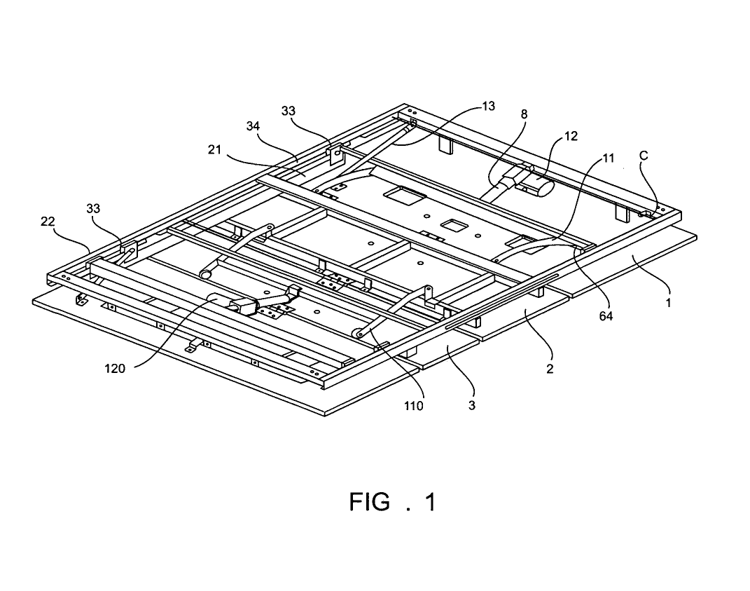

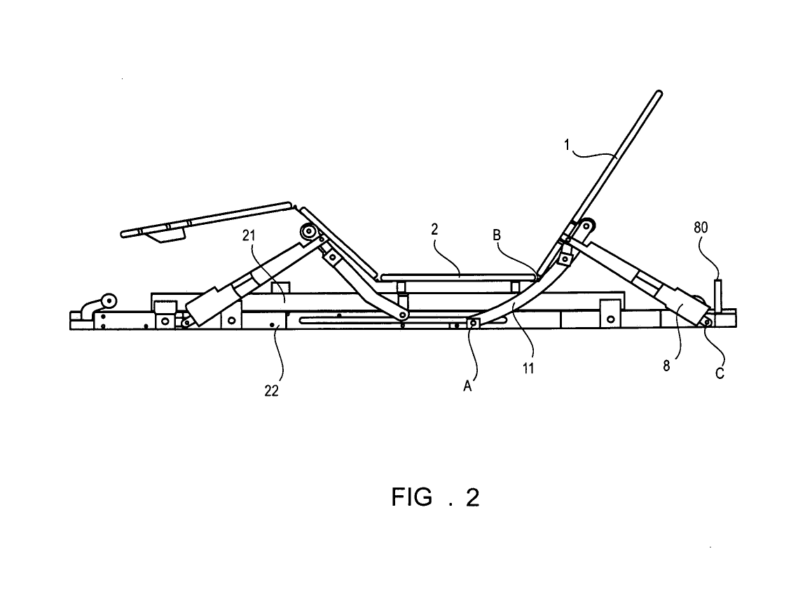

According to FIGS. 1, 2, the electric bed of the preferred embodiment includes the first bed board 1 and the second bed board 2, which are hinged with each other, as well as a connecting shaft between them called the second shaft B. The electric bed also includes the bed frame. The bed frame has an upper bed frame 21 and a lower bed frame 22. The electric bed further includes the head bracket 11, the head driving motor 12, and the head pull rod 13.

The second bed board 2 and the upper bed frame 21 are fixedly connected in the dismountable mode. The upper bed frame 21 and the lower bed frame 22 are connected by the guide rail connecting structure so that the upper bed frame can move relative to the lower bed frame 22.

Selectively, the guide rail connecting structure is a sliding structure with smooth movement property and good structure rigidity, such a slider and a sliding chute is not shown in the figure.

Preferably, the guide rail connecting structure is a rolling type structure. For example, the pulley wheel 33 and the guide rail 34, and the structure features small friction force and low noise.

The raising and falling of the first bed board 1 is achieved by the head bracket 11 and the head driving motor 12. One of the head bracket 11 and the bed frame are hinged with the first shaft A. Another end of the head bracket 11 is supported against the first bed board 1. The head driving motor 12 is fixed on the lower bed frame 22. The push rod of the driving motor 12 is hinged in a position close to another end of the head bracket 11 and crossly arranged with the head bracket 11.

The head driving motor 12 can move back-and-forth between an immobile position and back to a mobile position from the immobile position. The first bed board 1 is in a horizontal position, as shown in FIG. 1, and in the mobile position. The first bed board 1 is in a raising position, as shown in FIG. 2. Specifically, when the head driving motor 12 moves toward the mobile position from the immobile position, the head bracket 11 hinged with its push rod is driven to rotate around the first shaft A. As the head bracket 11 is supported against the first bed board 1, the torque is transmitted to the first bed board 1 so that the first bed board 1 is driven to rotate around the second shaft B. Thus, the first bed board 1 gradually rises from the horizontal position to the raised position. Conversely, when the head driving motor 12 moves toward the immobile position from the mobile position, the first bed board 1 gradually falls from the raised position to the horizontal position.

When the first bed board 1 moves from the horizontal position to the raising position, the head pull rod 13 rotates on an axle which is the third shaft C. The third shaft C is mounted to the bed frame. The head pull rod 13 has a hinged bracket connection to the first bed board 1. The first bed board 1 gradually offsets and moves toward the of the bed by the rotation of the head pull rod 13 as the first bed board 1 is driven to offset and move toward the head of the bed. As the first bed board 1 is hinged with the second bed board 2, the second bed board 2 offsets toward the bed head also so that the upper bed frame 21 fixedly connected with it offsets and moves toward the bed head also. As the lower bed frame 22 is fixed, the upper bed frame 21 moves relative with the lower bed frame 22.

Selectively, another end of the head bracket 11 supported against the first bed board 1 includes the guiding element, e.g. a trolley wheel. Therefore, the first bed board 1 bears smaller friction force during raising and falling to reduce the wearing of the bed board. Additionally, the first bed board 1 further includes the guiding device for receiving the guiding element. The guiding device may be a metal or wear-resisting plastic groove with higher strength than the board, thereby ensuring that the guiding element moves in the direction set by the guiding device and further reducing the wearing caused by supporting the head bracket 11 against the first bed board 1 and especially wearing caused when the first bed board rotates around the second shaft B.

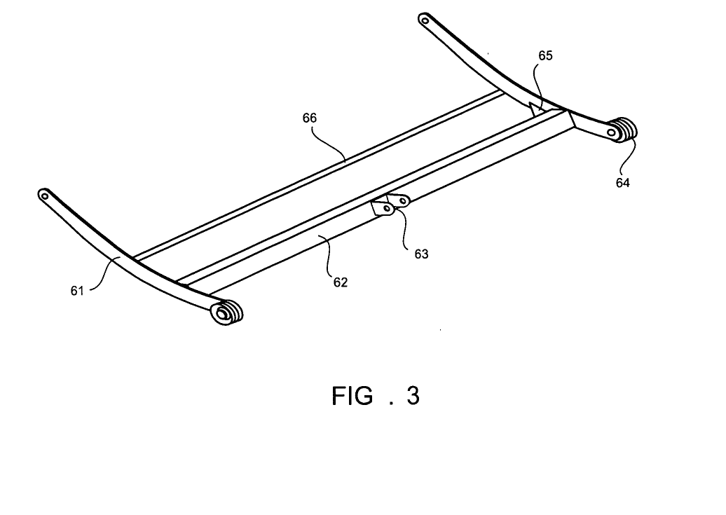

As shown in FIG. 3, the head bracket 11 has two side substrates 61, a cross-bar 62, bracket 63 and two guide wheels 64. Two ends of the cross-bar 62 are respectively connected with two side substrates 61, bracket 63 are separately arranged on the cross-bar 62. Two guide wheels 64 are arranged on one end of two side substrates 61. Another end of two side substrates of the head bracket 11 is respectively hinged with two sides of the middle front part of the lower bed frame 22. Two guide wheels on one end of two side substrates of the head bracket 11 are respectively supported against the bottom of the first bed board 1. One end of a front electrical expansion link 8 is hinged with the middle front part of the lower bed frame 22, and another end is hinged with two ears of the cross-bar of the head bracket 11. The distance between another end of the front electrical expansion link 8 hinged with the ear and the first shaft A is greater than the distance between it and the second shaft B.

Optionally, the head bracket 11 also includes at least one rib plate 65. Alternatively, the head bracket 11 also has a rectangular tube and/or a reinforcing rib 66. This depends on the type and purpose of the electric bed, for example, the rib plate, rectangular tube and/or reinforcing rib increasing rigidness may not be added to a single bed. One or more rib plates, rectangular tubes and/or reinforcing ribs may be added for a double bed.

Driving the first bed board 1 by the head driving motor 12 is detailed hereinafter. When the head driving motor 12 operates, the head bracket 11 hinged with its push rod is driven to rotate around the first shaft A, and another end of the head bracket 11 rotates against the first bed board 1 so that the first bed board 1 rotates around the second shaft B to form double axis movement.

Additionally, the electric bed also has a third bed board 3 hinged with the second bed board 2, and a foot bracket 110 with a foot driving motor 120. One end of the foot bracket 110 is hinged with the bed frame, and another end of the foot bracket 110 is supported against the third bed board 3. The foot driving motor 120 is fixed on the upper bed frame 21. The push rod of the foot driving motor 120 is hinged in a position close to another end of the foot bracket 110 and crossly arranged with the foot bracket 110. The foot driving motor 120 can move back-and-forth between the immobile position and the mobile position. In the immobile position, the third bed board 3 is in a horizontal position, whereas in the mobile position, the third bed board 3 is in a raising position. The electric bed is slimmer with the head driving motor 12 driving the first bed board 1 in operating mode and structure.

Furthermore, the electric bed further comprises the supporting block 80, e.g. an elastomer or a trolley wheel, used for supporting the bed board in the horizontal position. At the same time, the supporting block can reduce vibration before the first bed board 1 falls from the raising position to the front supporting block, and providing elastic support in the horizontal position so that the user feels more comfortable.

The electric bed has a simple and reasonable structure in which the head motor is crossly connected with the head bracket, the hinge joint between the head bracket and the bed frame is far away from the second bed board to bear some force for the motor of the head expansion link of the head motor during the raising of the first bed board so that the bearing capacity of the motor is reduced. At the same time, the hinge joint between the expansion link of the head motor and the lower bed frame is far away from the hinge joint between the head bracket and the bed frame to ensure the effective torque of the expansion link of the head motor, similarly playing a role in reduction of the bearing capacity of the motor.

The head bracket of the electric bed is in bottom contact with the guide wheel and the first bed board, the guide wheel rolls on the bottom of the first bed board so that the bed board is not limited by the head bracket during lifting. At the same time, after the guide wheel is used, the first bed board may be lifted manually, thereby ensuring safety without impact on the use function of the electric bed. The supporting block is used for supporting the bed board to avoid the collapse of the bed board.

When the electric bed is used, the user may place his head and back in the first bed board and his haunch on the second bed board, and obtain the most comfortable position by adjusting the different angle of the first bed board. The embodiment is only for a non-restrictive description and a person skilled in the field can achieve the same effect by reasonable modifications on the basis of this embodiment.

1. An electric bed comprising:
a. a first bed board and a second bed board, which are hinged with each other, wherein the first bed board has a horizontal position and a raised position;
b. a bed frame, wherein the bed frame comprises an upper bed frame and a lower bed frame;
c. a head bracket having a roller wheel that rolls on a lower surface of the first bed board, wherein the head bracket is hinged to the bed frame;
d. a head driving motor that pushes the head bracket, wherein the head bracket is configured to raise the first bed board when the head driving motor pushes the head bracket; and
e. a head pull rod hingedly connected between the first bed board and the bed frame.

2. The electric bed of claim 1 wherein, the second bed board and the upper bed frame are fixedly connected in a dismountable mode; the upper bed frame and the lower bed frame are connected by a guide rail connecting structure so that the upper bed frame can move relative to the lower bed frame; and wherein one end of the head bracket is hinged with the bed frame and another end of the head bracket is supported against the first bed board

3. The electric bed of claim 1 wherein, the head driving motor is fixed on the lower bed frame, the push rod of the driving motor is hinged in a position close to another end of the head bracket and crossly arranged with the head bracket, wherein, the head driving motor can move back-and-forth between an immobile position and a mobile position; wherein in the immobile position, the first bed board is in a horizontal position, whereas in the mobile position, the first bed board is in a raising position; wherein when the first bed board moves toward the raising position from the horizontal position, the head pull rod makes fixed-axis rotation with the first bed board so that the upper bed frame is driven to move relative to the lower bed frame.

4. The electric bed of claim 1 wherein, another end of the head bracket supported against the first bed board comprises a guiding element so that the first bed board arises or falls.

5. The electric bed of claim 1 wherein, the first bed board comprises a guiding device for receiving the guiding element to ensure the guiding element moves along the direction set by the guiding device.

6. The electric bed of claim 1 wherein, the head bracket has at least one reinforcing rib plate.

7. The electric bed of claim 1 wherein, the head bracket comprises a rectangular tube.

8. The electric bed of claim 1 wherein, when the head driving motor operates, it drives the head bracket hinged with its driving rod to rotate around a primary shaft and another end of the head bracket to rotate against the first bed board so that the first bed board rotates around a second shaft to form double-axis rotation.

9. The electric bed of claim 1 wherein, the electric bed further comprises:
a. a second bed board and a third bed board, which are hinged with each other;
b. foot bracket; and
c. a foot driving motor, wherein one end of the foot bracket is hinged with the bed frame and another end of the foot bracket is supported against the third bed board; wherein the foot driving motor is fixed on the upper bed frame; wherein the push rod of the driving motor is hinged in a position close to another end of the head bracket and crossly arranged with the head bracket; wherein the foot driving motor can move back-and-forth between an immobile position and a mobile position; wherein in the immobile position, the third bed board is in a horizontal position, whereas in the mobile position, the third bed board is in a raising position.

10. The electric bed of claim 1 wherein, the electric bed further comprises a supporting block for supporting the bed board positioned in the horizontal position.

11. The electric bed of claim 1 wherein, one end of the head bracket of the electric bed is hinged with the bed frame, another end is supported against the first bed board, one end of the head driving motor is hinged with the lower bed frame, another end is hinged with the head bracket to indirectly push the first bed board, and the head bracket is used to increase force arm and improve torque so that the first bed board raises.
